(19) United States
(12) Patent Application Publication
(10) Pub. No.: US 2026/0370788 A1
(43) Pub. Date: Nov. 19, 2026

(54) IMAGE PROCESSING METHOD AND APPARATUS, STORAGE MEDIUM, AND ELECTRONIC DEVICE

(71) Applicants: Beijing BOE Technology Development Co., Ltd., Beijing (CN); BOE Technology Group Co., Ltd., Beijing (CN)

(72) Inventors: Siyan MA, Beijing (CN); Lili CHEN, Beijing (CN); Wenyu LI, Beijing (CN); Zhifu LI, Beijing (CN); Yan LI, Beijing (CN)

(73) Assignees: Beijing BOE Technology Development Co., Ltd., Beijing (CN); BOE Technology Group Co., Ltd., Beijing (CN)

(21) Appl. No.: 19/475,828

(22) PCT Filed: Apr. 17, 2024
(86) PCT No.: PCT/CN2024/088397

§ 371 Date: Oct. 16, 2025

(30) Foreign Application Priority Data
May 29, 2023 (CN) 202310622670.6

(51) Int. Cl. H04N 13/117; G06F 3/01; G06T 7/50; G06T 7/73; G06T 19/20; G06V 10/26; G06V 40/16

(52) U.S. Cl. CPC H04N 13/117; G06F 3/013; G06T 7/50; G06T 7/73; G06T 19/20; G06V 10/273; G06V 40/166; G06V 40/171; G06T 2207/20221; G06T 2207/30201; G06T 2210/56; G06T 2219/2016

(57) ABSTRACT

An image processing method, a storage medium, and an electronic device are provided. The method includes: acquiring a target depth image collected by a depth camera and target color images collected by color cameras; projecting an original three-dimensional point cloud corresponding to the target depth image onto the target color image based on a matrix transformation relationship, and determining an input viewpoint image based on matched projection points; determining a user's gaze, determining, based on the user's gaze, a corresponding second gaze region in the input viewpoint image, and performing image fusion processing based on a gaze region image corresponding to the second gaze region, to acquire a high-definition gaze region image; scaling and fusing the input viewpoint image to acquire a low-definition image; and performing image fusion processing on the high-definition gaze region image and the low-definition image to acquire a to-be-displayed virtual viewpoint image.

### CROSS REFERENCE TO RELATED APPLICATION(S)

This application claims priority to Chinese Patent Application No. 202310622670.6, filed on May 29, 2023, entitled “IMAGE PROCESSING METHOD AND APPARATUS, STORAGE MEDIUM, AND ELECTRONIC DEVICE”, the entire content of which is incorporated herein by reference in its entirety.

### TECHNICAL FIELD

The present disclosure relates to a field of image processing technology, and in particular to an image processing method, an image processing apparatus, a storage medium, and an electronic device.

### BACKGROUND

In application scenarios such as remote video communication, VR games, etc., a holographic image may be created for a user in a call, thereby providing the user with a complete and realistic visual experience. Taking a scenario of holographic remote video communication as an example, high-definition images of the user and the scene shot usually by a plurality of cameras (color cameras or depth cameras) may be encoded and transmitted to a user device at the other end via the network. The images may be decoded on the device to be restored to original viewpoint images, and one or more specified virtual viewpoint images may be generated based on user needs, and then displayed on an autostereoscopic 3D display device to present a holographic communication effect to the user. However, at present, an algorithm for generating a high-resolution virtual viewpoint image in a dynamic scene is usually completed using a deep learning algorithm. This may lead to a long-time consumption due to excessive computation when generating the high-resolution (1 k*1 k or above) virtual viewpoint image, so that a system may not be displayed in real time, resulting in display lag.

It should be noted that the information disclosed in the above-mentioned background section is only used to improve an understanding of the background of the present disclosure, and thus information that does not constitute the prior art known to those skilled in the art may be included.

### SUMMARY

According to a first aspect of the present disclosure, an image processing method is provided, including:
acquiring a target depth image collected by a depth camera and target color images collected by color cameras, where the target color images include a plurality of color images respectively collected by a plurality of color cameras;
projecting an original three-dimensional point cloud corresponding to the target depth image onto the target color image based on a matrix transformation relationship between the depth camera and the color camera, and determining an input viewpoint image based on matched projection points;
determining a user's gaze, determining, based on the user's gaze, a corresponding second gaze region in the input viewpoint image, and performing image fusion processing based on a gaze region image corresponding to the second gaze region, so as to acquire a high-definition gaze region image;
scaling and fusing the input viewpoint image to acquire a low-definition image; and
performing image fusion processing on the high-definition gaze region image and the low-definition image to acquire a to-be-displayed virtual viewpoint image.

In some exemplary embodiments, the determining a user's gaze, and determining a corresponding second gaze region in the input viewpoint image based on the user's gaze direction includes:
determining a first user's gaze region in a current virtual viewpoint image on a display screen, and projecting the first gaze region onto the target color image, so as to determine the second gaze region in the input viewpoint image.

In some exemplary embodiments, the determining a first user's gaze region in a current virtual viewpoint image on a display screen includes:
performing key point detection on a facial image collected by a first camera to determine key point coordinates of key points in a facial image coordinate system;
performing circular fitting processing based on key point coordinates of eye key points, so as to determine pupil coordinates of an eye pupil in a first camera coordinate system;
   performing plane fitting processing based on key point pixel coordinates of the eye key points, and determining eye center coordinates of an eye center point in a face coordinate system based on a fitted plane; and determining eye center coordinates of the eye center point in the first camera coordinate system based on a coordinate transformation relationship between the first camera and the face coordinate system;
   determining, based on a coordinate transformation relationship between the first camera coordinate system and a screen coordinate system, a gaze direction in the screen coordinate system using the pupil coordinates and the eye center coordinates; and
   delineating a gaze region based on the gaze direction.

In some exemplary embodiments, the performing key point detection on a facial image collected by a first camera and determining key point coordinates of key points in a facial image coordinate system includes:
performing face detection on the facial image to determine pixel coordinates of preset key points in an image coordinate system;
determining key point coordinates of the key points in the first camera coordinate system based on a coordinate transformation relationship between the image coordinate system and the first camera coordinate system; and
acquiring a transformation matrix between the face coordinate system and the first camera coordinate system, so as to acquire key point coordinates of the key points in the face coordinate system using the transformation matrix.

In some exemplary embodiments, the performing circular fitting processing based on key point coordinates of eye key points, so as to determine pupil coordinates of an eye pupil in a first camera coordinate system includes:
acquiring an eye region image based on an eye key point set;
performing circular fitting processing on the eye region image, so as to acquire pixel coordinates of the eye pupil in an image coordinate system;
calculating an average depth value based on coordinate information of key points in the eye key point set in the first camera coordinate system, and determining the average depth value as a depth value of the eye pupil; and
determining the pupil coordinates of the eye pupil in the first camera coordinate system by combining the pixel coordinates of the eye pupil in the image coordinate system and the depth value of the eye pupil.

In some exemplary embodiments, the determining eye center coordinates of an eye center point in a face coordinate system based on a fitted plane includes:
determining a geometric center of the fitted plane;
constructing a perpendicular line of the fitted plane passing through the geometric center in a first direction; and
determining a point at a preset length of the perpendicular line as the eye center point, so as to acquire the eye center coordinates of the eye center point in the face coordinate system.

In some exemplary embodiments, the projecting an original three-dimensional point cloud corresponding to the target depth image onto the target color image based on a matrix transformation relationship between the depth camera and the color camera, so as to determine an input viewpoint image based on matched projection points includes:
projecting the original three-dimensional point cloud corresponding to the target depth image onto each target color image based on a transformation relationship between the depth camera and the color camera, so as to acquire depth information of matched projection points in each target color image; and
projecting the matched projection points in the target color image onto a preset virtual viewpoint image, so as to acquire a plurality of input viewpoint images.

In some exemplary embodiments, the method further includes: performing image recognition on the target color image, and removing a background region based on the image recognition result, so as to calculate the input viewpoint image based on the target color image with the background region removed.

According to a second aspect of the present disclosure, an image processing apparatus is provided, including:
an image data acquisition module configured to acquire a target depth image collected by a depth camera and target color images collected by color cameras, where the target color images include a plurality of color images respectively collected by a plurality of color cameras;
a projection transformation module configured to project an original three-dimensional point cloud corresponding to the target depth image onto the target color image based on a matrix transformation relationship between the depth camera and the color camera, and determine an input viewpoint image based on matched projection points;
a high-definition image acquisition module configured to determine a user's gaze, determine, based on the user's gaze, a corresponding second gaze region in the input viewpoint image, and perform image fusion processing based on a gaze region image corresponding to the second gaze region, so as to acquire a high-definition gaze region image;
a low-definition image acquisition module configured to scale and fuse the input viewpoint image to acquire a low-definition image; and
a virtual viewpoint image generation module configured to perform image fusion processing on the high-definition gaze region image and the low-definition image to acquire a to-be-displayed virtual viewpoint image.

According to a third aspect of the present disclosure, a storage medium having a computer program stored thereon is provided, where the computer program, when executed by a processor, is configured to implement the above-mentioned image processing method.

According to a fourth aspect of the present disclosure, an electronic device is provided, including:
a processor; and
a memory configured to store executable instructions of the processor, where the processor is configured to implement the above-mentioned image processing method by executing the executable instructions.

It should be understood that the above-mentioned general descriptions and the following detailed descriptions are merely exemplary and explanatory, and are not intended to limit the present disclosure.

### BRIEF DESCRIPTION OF THE DRAWINGS

The accompanying drawings, which are incorporated into and constitute a part of the specification, illustrate embodiments consistent with the present disclosure and serve to explain the principles of the present disclosure together with the specification. Obviously, the accompanying drawings in the following descriptions are for some embodiments of the present disclosure. For those skilled in the art, other accompanying drawings may also be obtained according to these accompanying drawings without any creative work.

FIG. 1 schematically shows a schematic diagram of an image processing method according to exemplary embodiments of the present disclosure.

FIG. 2 schematically shows a schematic diagram of a system architecture according to exemplary embodiments of the present disclosure.

FIG. 3 schematically shows a schematic diagram of camera position distribution according to exemplary embodiments of the present disclosure.

FIG. 4 schematically shows a schematic diagram of position distribution of facial key points according to exemplary embodiments of the present disclosure.

FIG. 5 schematically shows a schematic diagram of a gaze region according to exemplary embodiments of the present disclosure.

FIG. 6 schematically shows a schematic diagram of composition of an image processing apparatus according to exemplary embodiments of the present disclosure.

FIG. 7 schematically shows a schematic diagram of composition of an electronic device according to exemplary embodiments of the present disclosure.

### DETAILED DESCRIPTION OF EMBODIMENTS

Exemplary embodiments will now be described more fully with reference to the accompanying drawings. However, the exemplary embodiments may be implemented in various forms and should not be construed as being limited to the examples set forth herein. On the contrary, these embodiments are provided to make the present disclosure more comprehensive and complete, and to fully convey the concept of exemplary embodiments to those skilled in the art. The described features, structures, or characteristics may be combined in any suitable manner in one or more embodiments

In addition, the accompanying drawings are only schematic illustrations of the present disclosure and are not necessarily drawn to scale. The same reference numerals in the drawings indicate the same or similar components, and therefore repeated descriptions thereof will be omitted. Some block diagrams shown in the accompanying drawings are functional entities and do not necessarily correspond to physically or logically independent entities. These functional entities may be implemented in a form of software, or implemented in one or more hardware modules or integrated circuits, or implemented in different networks and/or processor apparatuses and/or microcontroller apparatuses.

In the related art, in a field of holographic remote video communication, in order to provide a customer with a complete and realistic visual experience, high-definition images of the user and the scene shot usually by a plurality of cameras (color cameras or depth cameras) may be encoded and transmitted to a user device at the other end via the network. The images may be decoded on the device to be restored to original viewpoint images, and one or more specified virtual viewpoint images may be generated based on user needs, and then displayed on an autostereoscopic 3D display device to present a holographic communication effect to the user. However, at present, an algorithm for generating a high-resolution virtual viewpoint image in a dynamic scene is usually completed using a deep learning algorithm. This may lead to a long-time consumption due to excessive computation when generating the high-resolution virtual viewpoint image, so that a system may not be displayed in real time, resulting in display lag.

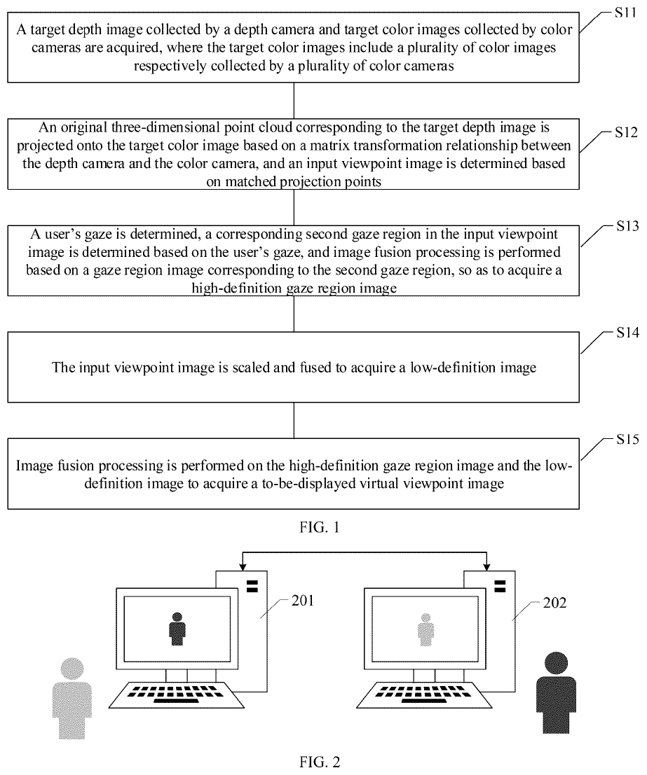

In view of the shortcomings and deficiencies in the prior art, this exemplary embodiment provides an image processing method, which may be applied to the generation of a holographic image. Referring to FIG. 1, the image processing method provided may include the following steps S11 to S15.

In the step S11, a target depth image collected by a depth camera and target color images collected by color cameras are acquired, where the target color images include a plurality of color images respectively collected by a plurality of color cameras.

In the step S12, an original three-dimensional point cloud corresponding to the target depth image is projected onto the target color image based on a matrix transformation relationship between the depth camera and the color camera, and an input viewpoint image is determined based on matched projection points.

In the step S13, a user's gaze is determined, a corresponding second gaze region in the input viewpoint image is determined based on the user's gaze, and image fusion processing is performed based on a gaze region image corresponding to the second gaze region, so as to acquire a high-definition gaze region image.

In the step S14, the input viewpoint image is scaled and fused to acquire a low-definition image.

In the step S15, image fusion processing is performed on the high-definition gaze region image and the low-definition image to acquire a to-be-displayed virtual viewpoint image.

By the image processing method provided by this exemplary embodiment, the original three-dimensional point cloud corresponding to the target depth image is projected onto each target color image to determine a plurality of corresponding input viewpoint images based on the projection points, and then image fusion is performed on an image of the second gaze region in each input viewpoint image based on the user's gaze, so that the high-definition gaze region image of the user's gaze region may be obtained. Then, each input viewpoint image is scaled and fused to obtain the low-definition image. Next, fusion processing is performed on the high-definition gaze region image and the low-definition image to obtain the virtual viewpoint image. In this way, the user's gaze region may be generated with its original size maintained, and a non-gaze region may be downscaled to a specified size, which may effectively reduce a volume of data involved in computation and a computation load of a model.

The steps of the image processing method in this exemplary embodiment will be described below in more detail with reference to the accompanying drawings and embodiments.

In the step S11, the target depth image collected by the depth camera and the target color images collected by the color cameras are acquired, where the target color images include the plurality of color images respectively collected by the plurality of color cameras.

In this exemplary embodiment, referring to a system architecture shown in FIG. 2, in a holographic image-based remote video communication scenario, a transmitting end 201 and a receiving end 202 may be provided. Data transmission may be performed between the transmitting end 201 and the receiving end 202 through a network such as a wired communication link or a wireless communication link. Referring to FIG. 3, terminal devices of the transmitting end 201 and the receiving end 202 may include a display screen. A color camera C0 is provided at a center of an upper end of the display screen as a face capture camera; a depth camera D0 is provided below the camera C0 to acquire depth information of the user's gaze region; color cameras C1 to C4 are symmetrically provided at each corner of the display screen, so as to collect original viewpoint images. For each camera, a user's experience region is about 1 meter away from the screen. An angle of each camera may be adjusted, so that an optical axis of each camera intersects at a center of the human body, and a field of view of each camera may fully cover a region where the human body is located. The display screen may be an autostereoscopic 3D display device.

On each terminal device side, transformation matrices ^{j}Tᵢ,i≠j,i,j=C0, C1, C2, C3, C4, D0 between the cameras (color cameras and depth cameras), intrinsic parameters Kᵢ, i=C0, C1, C2, C3, C4, D0 of each camera, and a transformation matrix ^{s}T_{C0} from a color camera CO coordinate system to a screen coordinate system may be calibrated in advance using a calibration board and a plane mirror. A position of a virtual viewpoint may be set based on user needs, which is determined by setting ^{C0}Tₙ, and its intrinsic parameter is Kₙ.

The terminal device may control the color cameras and the depth camera provided on the display screen to synchronously collect the color images and the depth image, and transmit them to a peer terminal device in real time. At the same time, the intrinsic parameters of each camera and the transformation matrix between the camera coordinate systems may be transmitted to a peer device.

Alternatively, in some exemplary embodiments, the above-mentioned method may further include: performing image recognition on the target color image, and removing a background region based on the image recognition result, so as to calculate the input viewpoint image based on the target color image with the background region removed.

Specifically, for the terminal device, after capturing the color images and the depth image using the color cameras C1 to C4 and the depth camera D0, image recognition processing may be first performed to extract a human body region in the images and remove the background region; and then the target color images containing only the human body region may be sent to the peer device, which may reduce a volume of data for image transmission and improve an efficiency of data transmission. Alternatively, after receiving the target color images, background recognition may be first performed, the background region in the color images may be removed, and only the human body region may be retained as the target color images, which may improve an efficiency of subsequent projection point calculation. For example, the background region may be removed using a classical background removal algorithm such as Back Ground Matting, etc., and only the user's body region in the color images may be retained.

In the step S12, the original three-dimensional point cloud corresponding to the target depth image is projected onto the target color image based on the matrix transformation relationship between the depth camera and the color camera, and the input viewpoint image is determined based on the matched projection points

In this exemplary embodiment, the above-mentioned step S12 may include the following steps S121 to S122.

In the step S121, the original three-dimensional point cloud corresponding to the target depth image is projected onto each target color image based on a transformation relationship between the depth camera and the color camera, so as to acquire depth information of matched projection points in each target color image.

In the step S122, the matched projection points in the target color image are projected onto a preset virtual viewpoint image, so as to acquire a plurality of input viewpoint images.

Specifically, the color images collected by the color cameras C1 to C4, i.e., the target color images, may be used as original viewpoint images. The target depth image collected by the depth camera may first be transformed into corresponding original three-dimensional point cloud data. For the acquired original three-dimensional point cloud data, a user's body region in the original three-dimensional point cloud data may be projected onto each target color image using a pre-calibrated transformation matrix between a depth camera coordinate system and a color camera coordinate system and the camera intrinsic parameters, thereby acquiring depth information corresponding to pixel points in the human body region on each color image. Specifically, when projecting the original three-dimensional point cloud onto the target color images, if projection points are not within the human body region, the pixel points may be discarded from the target color images. After acquiring the depth information of the pixel points in the human body region on each target color image, the pixel points may be projected onto a virtual viewpoint image expected to be acquired, and pixel values thereof are colors on the target color images. So far, the input viewpoint images corresponding to each target color image may be acquired.

Alternatively, when the target color image for which projection operation is performed is a human body region image, during the projection of the depth image onto the target color image, if any pixel point in the human body region on the color image lacks a corresponding projection point, depth information corresponding to a projection point closest to the pixel point may be selected for replacement as the depth information of the pixel point.

In the step S13, the user's gaze is determined, the corresponding second gaze region in the input viewpoint image is determined based on the user's gaze, and the image fusion processing is performed based on the gaze region image corresponding to the second gaze region, so as to acquire the high-definition gaze region image.

In this exemplary embodiment, the terminal device may calculate a current user's gaze region on the display screen in real time using the image collected by the camera C0. Therefore, the step S13 may be executed synchronously with the step S12. Alternatively, the terminal device may calculate a gaze region corresponding to the user's gaze in advance.

In this exemplary embodiment, the determining a user's gaze, and determining a corresponding second gaze region in the input view point image based on the user's gaze includes: determining a first gaze region of the user's gaze in a current virtual viewpoint image on a display screen, and projecting the first gaze region onto the target color image, so as to determine the second gaze region in the input viewpoint image.

Specifically, the determining a first gaze region of the user's gaze in a current virtual viewpoint image on a display screen includes the following steps S21 to S25.

In the step S21, key point detection is performed on a facial image collected by a first camera to determine key point coordinates of key points in a facial image coordinate system.

In the step S22, circular fitting processing is performed based on key point coordinates of eye key points, so as to determine pupil coordinates of an eye pupil in a first camera coordinate system.

In the step S23, plane fitting processing is performed based on key point pixel coordinates of the eye key points, and eye center coordinates of an eye center point in a face coordinate system are determined based on a fitted plane; and eye center coordinates of the eye center point in the first camera coordinate system are determined based on a coordinate transformation relationship between the first camera and the face coordinate system.

In the step S24, based on a coordinate transformation relationship between the first camera coordinate system and a screen coordinate system, a gaze direction in the screen coordinate system is determined using the pupil coordinates and the eye center coordinates.

In the step S25, a gaze region is delineated based on the gaze direction.

In this exemplary embodiment, in the above-mentioned step S21, the performing key point detection on a facial image collected by a first camera and determining key point coordinates of key points in a facial image coordinate system includes:
performing face detection on the facial image to determine pixel coordinates of preset key points in an image coordinate system;
determining key point coordinates of the key points in the first camera coordinate system based on a coordinate transformation relationship between the image coordinate system and the first camera coordinate system; and
acquiring a transformation matrix between the face coordinate system and the first camera coordinate system, so as to acquire key point coordinates of the key points in the face coordinate system using the transformation matrix.

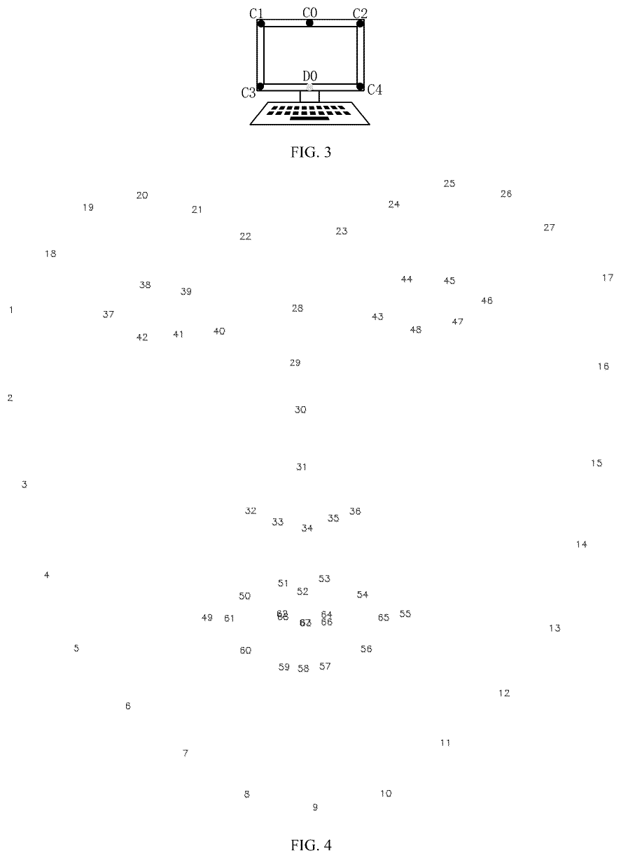

Specifically, the first camera may be the above-mentioned color camera C0. Referring to FIG. 4, a face may be pre-configured with a corresponding key point distribution position. When the facial image is collected by the color camera C0, distortion correction may be performed first. For the facial image after distortion correction, coordinates of each pixel point in the facial image coordinate system may be acquired. Based on a key point distribution shown in FIG. 4, pixel coordinates (u₀, v₀)-(u₆₇, v₆₇) of 68 key points in the facial image may be detected. Coordinates of each key point in the camera C0 coordinate system may be determined using intrinsic parameters of the camera C0. By making pixel coordinates of each key point in the facial image in one-to-one correspondence with a face template in the face coordinate system, one-to-one correspondence between the face template in the face coordinate system and each key point in the facial image may be established using a pose estimation algorithm, so as to acquire a pose of the face in the camera C0 coordinate system. Based on coordinate information of the face template of each key point in the face coordinate system and pose information of the face in the camera C0 coordinate system, a transformation matrix ^{C0}T_{face} from the face coordinate system to the camera C0 coordinate system may be estimated. Based on the transformation matrix, three-dimensional coordinates (u₀, v₀)-(u₆₇, v₆₇) of each key point in the face coordinate system may be calculated.

In this exemplary embodiment, in the above-mentioned step S22, the performing circular fitting processing based on key point coordinates of eye key points, so as to determine pupil coordinates of an eye pupil in a first camera coordinate system includes:
acquiring an eye region image based on an eye key point set;
performing circular fitting processing on the eye region image, so as to acquire pixel coordinates of the eye pupil in an image coordinate system;
calculating an average depth value based on coordinate information of key points in the eye key point set in the first camera coordinate system, and determining the average depth value as a depth value of the eye pupil; and
determining the pupil coordinates of the eye pupil in the first camera coordinate system by combining the pixel coordinates of the eye pupil in the image coordinate system and the depth value of the eye pupil.

Specifically, referring to FIG. 4, for key points 37 to 42 corresponding to a left eye region, a pupil region may be acquired using conventional image algorithms such as binarization, erosion, dilation, etc., and circular fitting may be performed to obtain pixel coordinates (uₗ, vₗ) of a left eye pupil in an image. An average depth of the three-dimensional key points 37 to 42 is taken as a depth of the current left eye pupil in the camera C0 coordinate system, and its three-dimensional coordinates Pᵢ are calculated as (Xᵢ, Yᵢ, Zᵢ) based on intrinsic parameter K_{C0}. Accordingly, for key points 43 to 48 of a right eye region, three-dimensional coordinates of a right eye pupil in the camera C0 coordinate system may be acquired in the same way.

In this exemplary embodiment, in the above-mentioned step S23, the determining eye center coordinates of an eye center point in a face coordinate system based on a fitted plane may specifically include:
determining a geometric center of the fitted plane;
constructing a perpendicular line of the fitted plane passing through the geometric center in a first direction; and
determining a point at a preset length of the perpendicular line as the eye center point, so as to acquire the eye center coordinates of the eye center point in the face coordinate system.

Specifically, in the face coordinate system, for the left eye region, a plane P may be fitted using the key points 37 to 42, and a geometric center Center may be calculated. A perpendicular line L of the plane is constructed passing through Center in a direction toward the interior of the human head. It is known that a diameter of the human eye is approximately in a range of 21 mm to 25 mm, and a point 23 mm away from the perpendicular line is taken as a center Ce of the human eye, coordinates of a left eye center are (X_{C}_{ₑ}, Y_{C}_{ₑ}, Z_{C}_{ᵢ}). Similarly, with the key points 43 to 48, coordinates of a right eye center in the face coordinate system may be determined by the above-mentioned method. Then, based on the above-mentioned transformation matrix ^{C0}T_{face} between the camera C0 coordinate system and the face coordinate system, eye center coordinates of the left eye center and the right eye center in the camera C0 coordinate system may be calculated.

In this exemplary embodiment, in the above-mentioned step S24, in the camera CO coordinate system, a left eye's gaze may be determined based on the coordinates P2 of the left eye pupil and the coordinates of the left eye center. Similarly, a right eye's gaze may be determined using the coordinates of the right eye pupil and the coordinates of the right eye center. Based on the pre-calibrated transformation matrix ^{S}T_{C0} between the camera C0 coordinate system and the screen coordinate system, the left eye's gaze and the right eye's gaze are respectively transformed into the screen coordinate system, so as to determined gaze points of the left eye's gaze and the right eye's gaze on the screen, i.e., current gaze points of the user's gaze on the virtual viewpoint image.

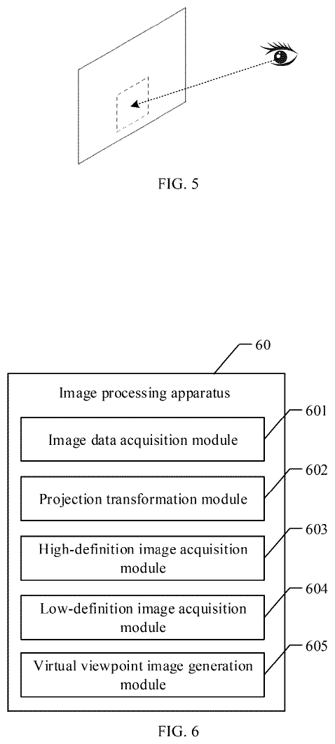

In this exemplary embodiment, in the above-mentioned step S25, based on the left eye's gaze points and the right eye's gaze points in the screen coordinate system, a gaze point connection line may be established, with a midpoint of the connection line as a center of the gaze region. Referring to FIG. 5, a rectangular region of r*r is taken as an eye's gaze region on the screen at this time, where r may be set based on user needs. After acquiring coordinates of the gaze region in the screen coordinate system, a gaze region Rect on the virtual viewpoint image may be determined based on a screen resolution and a physical size of the display device, i.e., the above-mentioned determined first gaze region of the user's gaze in the current virtual viewpoint image on the display screen. For example, a size of the first gaze region may be set to 256*256.

In this exemplary embodiment, in the step S13, for the collected target depth image, corresponding three-dimensional point cloud data may be transformed into a virtual viewpoint coordinate system through a transformation matrix ⁿT_{D}, and transformed into the virtual viewpoint image based on intrinsic parameters of the virtual viewpoint. A three-dimensional point cloud in the gaze region may be acquired from the gaze region Rect on the virtual viewpoint image, and then the point cloud is projected onto the input viewpoint images through a transformation matrix ⁱTₙ, i=C1, C2, C3, C4 and intrinsic parameters Kᵢ, i=C1, C2, C3, C4. The projection points are surrounded by a minimum rectangular frame. In order to ensure consistency in size, with a center of the minimum rectangular frame serving as a center, a region with the same size as Rect may be selected as a gaze region Rectᵢ, i=C1, C2, C3, C4 in each input viewpoint image. Therefore, the gaze region image in the corresponding second gaze region in each input viewpoint image may be obtained. The transformation matrix ⁿT_{D} may be a transformation matrix between the depth camera coordinate system and the virtual viewpoint coordinate system. The virtual viewpoint coordinate system may be a coordinate system corresponding to a virtual camera, and the virtual viewpoint image is a desired virtual viewpoint image, i.e., an image expected to be displayed on the autostereoscopic 3D display device.

A UNet network-based virtual viewpoint image generation model may be trained in advance. As an input of the model, gaze region images corresponding to 4 input viewpoint images may be concatenated along a channel dimension to form input data of 256*256*12. Image fusion processing may be performed using the model, so as to output the high-definition gaze region image. In general, the UNet network may include a backbone feature extraction network. Downsampling may be performed using the backbone part, so as to obtain a plurality of feature layers, and each feature extraction layer that performs the downsampling may be a stack of convolution and max-pooling. Five preliminary effective feature layers may be acquired from the backbone feature extraction part. The UNet network may further include an enhanced feature extraction network, which may perform upsampling using the five preliminary effective feature layers, and perform feature fusion to acquire a final effective feature layer that integrates all features. The UNet network may further include a prediction network, which may classify each feature point using the finally acquired effective feature layer, that is, classifying each pixel point.

In the step S14, the input viewpoint image is scaled and fused to acquire the low-definition image.

In this exemplary embodiment, scaling processing may be performed on each input viewpoint image. For example, an original size of 1024*1024 may be downscaled to a size of 256*256; then, the scaled input viewpoint image may be input into a UNet network-based image fusion model, so as to output a fused image with a size of 256*256; next, the image is then stretched to a size of 1024*1024, so as to obtain a low-definition image of a non-attention region.

In the step S15, the image fusion processing is performed on the high-definition gaze region image and the low-definition image to acquire the to-be-displayed virtual viewpoint image.

In this exemplary embodiment, after acquiring the high-definition gaze region image and the low-definition image, the image fusion processing may be performed on the two images to obtain a fused virtual viewpoint image. In order to make a transition between high-definition and low-definition regions smoother, mean filtering may be performed on a junction of the high-definition and low-definition regions, with a processing width of 1/16 of a side length of the high-definition region, i.e., 16 pixels. In the generated virtual viewpoint image, the user's gaze region is the high-definition image, and the remaining regions are the low-definition images.

The image processing method provided by embodiments of the present disclosure may be applied to the generation of the virtual viewpoint image in autostereoscopic 3D scenarios. The facial image may be collected by the color camera CO, and the user's gaze region on the screen may be calculated using the facial image, thereby determining a user's gaze region in the virtual viewpoint image. For the depth image collected by the depth camera DO and the color images collected by the color cameras C1 to C4, background recognition may be first performed on each image, the background region may be removed, and the human body region image may be retained. Based on the transformation matrix and intrinsic parameters between the cameras, the depth image may be projected onto each color image to determine the matched projection points, and then the input viewpoint image may be obtained. A corresponding gaze region on the input viewpoint image is used as a high-definition image and an input of a UNet network model, so that the high-definition image corresponding to the user's gaze region may be output. For example, a resolution of the original image may be 1024*1024. A gaze region image with a size of 256*256 is intercepted from each input viewpoint image and then input into a model for fusion processing, and a high-definition gaze region image with a size of 256*256 is output. At the same time, each input viewpoint image may be scaled from 1024*1024 to 256*256 and input into the model. The output image with a size of 256*256 is then stretched to 1024*1024 to obtain the low-definition image, thereby realizing hierarchical processing of a high-definition region and a low-definition region. Then, the image fusion processing is performed on the high-definition image and the low-definition image to acquire a virtual viewpoint image expected to be displayed. In this image, it may be ensured that the user's gaze region is high-definition, while the remaining regions are low-definition. In this way, a gaze region-based virtual viewpoint image generation solution may be provided, which may solve problems of large computation and a low frame rate in the generation of a high-resolution virtual viewpoint image in holographic remote video communication scenarios, and may significantly improve a frame rate of a virtual viewpoint image generation algorithm and enhance a user experience effect. By analyzing a user's gaze direction, the user's gaze region on the screen, i.e., the virtual viewpoint image, may be determined. For a gaze region focused on by the user, the virtual viewpoint image may be generated in an original size, while the non-gaze region may be generated by compressing it to a low resolution due to its low importance, which may effectively reduce a computation load of the model.

It should be noted that the above-mentioned accompanying drawings are only schematic descriptions of the processes included in the method according to exemplary embodiments of the present disclosure, and are not intended to limit the present disclosure. It will be appreciated that the processes shown in the above-mentioned accompanying drawings do not indicate or limit the time sequence of these processes. Furthermore, it will also be appreciated that these processes may be executed synchronously or asynchronously in a plurality of modules, for example.

Further, referring to FIG. 6, embodiments of the present disclosure further provide an image processing apparatus 60, which may be applied to a terminal device. The apparatus includes: an image data acquisition module 601, a projection transformation module 602, a high-definition image acquisition module 603, a low-definition image acquisition module 604, and a virtual viewpoint image generation module 605.

The image data acquisition module 601 may be used to acquire a target depth image collected by a depth camera and target color images collected by color cameras, where the target color images include a plurality of color images respectively collected by a plurality of color cameras.

The projection transformation module 602 may be used to project an original three-dimensional point cloud corresponding to the target depth image onto the target color image based on a matrix transformation relationship between the depth camera and the color camera, and determine an input viewpoint image based on matched projection points.

The high-definition image acquisition module 603 may be used to determine a user's gaze, determine, based on the user's gaze, a corresponding second gaze region in the input viewpoint image, and perform image fusion processing based on a gaze region image corresponding to the second gaze region, so as to acquire a high-definition gaze region image.

The low-definition image acquisition module 604 may be used to scale and fuse the input viewpoint image to acquire a low-definition image.

The virtual viewpoint image generation module 605 may be used to perform image fusion processing on the high-definition gaze region image and the low-definition image to acquire a to-be-displayed virtual viewpoint image.

In some exemplary embodiments, the high-definition image acquisition module 603 may be used to determine a first gaze region of the user's gaze in a current virtual viewpoint image on a display screen, and project the first gaze region onto the target color image, so as to determine the second gaze region in the input viewpoint image.

In some exemplary embodiments, the high-definition image acquisition module 603 may be used to perform key point detection on a facial image collected by a first camera to determine key point coordinates of key points in a facial image coordinate system; perform circular fitting processing based on key point coordinates of eye key points, so as to determine pupil coordinates of an eye pupil in a first camera coordinate system; perform plane fitting processing based on key point pixel coordinates of the eye key points, and determine eye center coordinates of an eye center point in a face coordinate system based on a fitted plane; and determining eye center coordinates of the eye center point in the first camera coordinate system based on a coordinate transformation relationship between the first camera and the face coordinate system; determine, based on a coordinate transformation relationship between the first camera coordinate system and a screen coordinate system, a gaze direction in the screen coordinate system using the pupil coordinates and the eye center coordinates; and delineate a gaze region based on the gaze direction.

In some exemplary embodiments, the high-definition image acquisition module 603 may be used to perform face detection on the facial image to determine pixel coordinates of preset key points in an image coordinate system; determine key point coordinates of the key points in the first camera coordinate system based on a coordinate transformation relationship between the image coordinate system and the first camera coordinate system; and acquire a transformation matrix between the face coordinate system and the first camera coordinate system, so as to acquire key point coordinates of the key points in the face coordinate system using the transformation matrix.

In some exemplary embodiments, the high-definition image acquisition module 603 may be used to acquire an eye region image based on an eye key point set; perform circular fitting processing on the eye region image, so as to acquire pixel coordinates of the eye pupil in an image coordinate system; calculate an average depth value based on coordinate information of key points in the eye key point set in the first camera coordinate system, and determine the average depth value as a depth value of the eye pupil; and determine the pupil coordinates of the eye pupil in the first camera coordinate system by combining the pixel coordinates of the eye pupil in the image coordinate system and the depth value of the eye pupil.

In some exemplary embodiments, the high-definition image acquisition module 603 may be used to determine a geometric center of the fitted plane; construct a perpendicular line of the fitted plane passing through the geometric center in a first direction; and determine a point at a preset length of the perpendicular line as the eye center point, so as to acquire the eye center coordinates of the eye center point in the face coordinate system.

In some exemplary embodiments, the projection transformation module 602 may be used to project the original three-dimensional point cloud corresponding to the target depth image onto each target color image based on a transformation relationship between the depth camera and the color camera, so as to acquire depth information of matched projection points in each target color image; and project the matched projection points in the target color image onto a preset virtual viewpoint image, so as to acquire a plurality of input viewpoint images.

In some exemplary embodiments, the apparatus further includes: an image background removal module. The image background removal module may be used to perform image recognition on the target color image, and remove a background region based on the image recognition result, so as to calculate the input viewpoint image based on the target color image with the background region removed.

It should be noted that although a plurality of modules or units of a device for action execution have been mentioned in the above-mentioned detailed descriptions, such a division is not mandatory. In fact, according to embodiments of the present disclosure, the features and functions of two or more modules or units described above may be embodied in a module or unit. On the contrary, the features and functions of a module or unit described above may be further divided to be embodied by a plurality of modules or units.

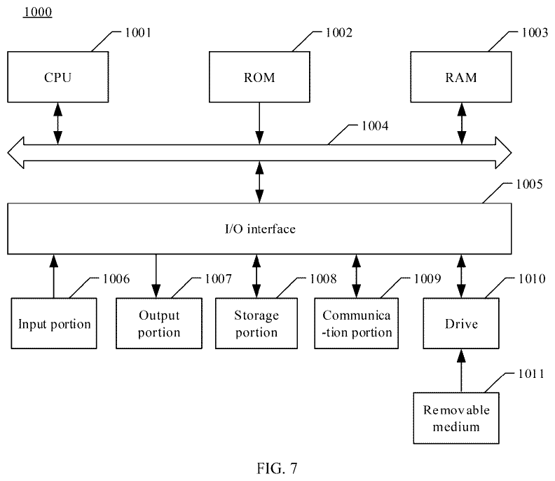

FIG. 7 shows a schematic diagram of an electronic device suitable for implementing embodiments of the present disclosure.

It should be noted that an electronic device 1000 shown in FIG. 7 is only an example, and is not intended to limit the functions and scope of use of embodiments of the present disclosure.

Referring to FIG. 7, the electronic device 1000 includes a central processing unit (CPU) 1001, which may perform various appropriate actions and processes according to a program stored in a read-only memory (ROM) 1002 or a program loaded from a storage portion 1008 into a random access memory (RAM) 1003. For example, the central processing unit 1001 may perform the steps shown in FIG. 1, so as to implement the above-mentioned pedestrian detection method. In the RAM 1003, various programs and data required for system operations are also stored. The CPU 1001, the ROM 1002, and the RAM 1003 are connected to each other via a bus 1004. An input/output (I/O) interface 1005 is also connected to the bus 1004.

The one or more of the following components are connected to the I/O interface 1005: an input portion 1006 including a keyboard, a mouse, etc.; an output portion 1007 such as a cathode ray tube (CRT), a liquid crystal display (LCD), etc., and a loudspeaker, etc.; a storage portion 1008 including a hard disk, etc.; and a communication portion 1009 including a network interface card such as a LAN (Local Area Network) card, a modem, etc. The liquid crystal display may be an autostereoscopic 3D display device. The communication portion 1009 performs communication processing via a network such as the internet. A drive 1010 is also connected to the I/O interface 1005 as required. A removable medium 1011, such as a magnetic disk, optical disk, magneto-optical disk, semiconductor memory, etc., is installed on the drive 1010 as required, so that computer programs read therefrom may be installed into the storage portion 1008 as required.

In particular, according to embodiments of the present disclosure, the processes described below with reference to the flowcharts may be implemented as a computer software program. For example, embodiments of the present disclosure include a computer program product, which includes a computer program loaded on a computer-readable storage medium, and the computer program includes a program code for performing the method shown in the flowchart. In the embodiment, the computer program may be downloaded and installed from the network through the communication portion 1009, and/or installed from the removable media 1011. When the computer program is executed by the CPU 1001, the above-mentioned functions defined in the system of embodiments of the present disclosure are performed.

Specifically, the above-mentioned electronic device may be an intelligent device such as a server, a tablet computer, or a laptop computer, and may perform the above-mentioned Internet of Things device interaction management method applied to a proxy server or an Internet of Things platform. Alternatively, the above-mentioned electronic device may also be an Internet of Things device, which may perform the above-mentioned Internet of Things device interaction management method applied to the Internet of Things device.

It should be noted that the storage medium shown in embodiments of the present disclosure may be a computer-readable signal medium or a computer-readable storage medium, or any combination of the two. The computer-readable storage medium may be, for example, but not limited to, an electrical, magnetic, optical, electromagnetic, infrared, or semiconductor system, apparatus, or component, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or component. In the present disclosure, the computer-readable signal medium may include a data signal propagated in a baseband or as part of a carrier wave, in which computer-readable program code is carried. Such propagated data signals may take various forms, including but not limited to an electromagnetic signal, an optical signal, or any suitable combination thereof. The computer-readable signal medium may also be any storage medium other than the computer-readable storage medium, and the storage medium may send, propagate, or transmit a program for use by or in combination with an instruction execution system, apparatus, or component. The program code contained on the storage medium may be transmitted by any appropriate medium, including but not limited to: wireless, wired, etc., or any suitable combination thereof.

The flowcharts and block diagrams in the accompanying drawings illustrate possibly implemented architectures, functions and operations of the systems, methods and computer program products according to various embodiments of the present disclosure. In this regard, each block in the flowcharts or block diagrams may represent a module, a program segment, or part of a code. The above-mentioned module, program segment, or part of the code contains one or more executable instructions for realizing specified logic functions. It should also be noted that, in some alternative implementations, functions marked in the blocks may also occur in a different order from those marked in the accompanying drawings. For example, two consecutive blocks may actually be performed in parallel, and sometimes they may be performed in a reverse order, which depends on the functions involved. It should also be noted that each block in the block diagrams or flowcharts and a combination of blocks in the block diagrams or flowcharts may be implemented by a dedicated hardware-based system that performs specified functions or operations, or by a combination of a dedicated hardware and computer instructions.

The units involved in embodiments of the present disclosure may be implemented in a form of software, or may be implemented in a form of hardware. The described units may also be provided in a processor. The names of these units do not constitute a limitation on the units themselves in some cases.

It should be noted that another aspect of the present application further provides a storage medium, which may be contained in the electronic device; or may exist independently without being assembled into the electronic device. The above-mentioned storage medium carries one or more programs, and the above-mentioned one or more programs, when executed by an electronic device, cause the electronic device to implement the method described in the following embodiments. For example, the electronic device may implement the steps of the method applied to a proxy server, an Internet of Things platform, or an Internet of Things device.

In addition, the above-mentioned accompanying drawings are only schematic descriptions of the processes included in the method according to exemplary embodiments of the present disclosure, and are not intended to limit the present disclosure. It will be appreciated that the processes shown in the above-mentioned accompanying drawings do not indicate or limit the time sequence of these processes. Furthermore, it will also be appreciated that these processes may be executed synchronously or asynchronously in a plurality of modules, for example.

After considering the specification and practicing the present disclosure herein, those skilled in the art may easily conceive of other embodiments of the present disclosure. The application is intended to cover any variations, uses, or adaptive changes of the present disclosure. These variations, uses, or adaptive changes comply with the general principles of the present disclosure and include common knowledge or conventional technical means in the technical field not disclosed in the present disclosure. The specification and embodiments are to be regarded as exemplary only, and the true scope and spirit of the present disclosure are indicated by the claims.

It should be understood that the present disclosure will not be limited to the precise structure that has been described above and shown in the accompanying drawings, and various modifications and changes may be made without departing from the scope of the present disclosure. The scope of the present disclosure is only defined by the appended claims.

1. An image processing method, comprising:
acquiring a target depth image collected by a depth camera and target color images collected by color cameras, wherein the target color images comprise a plurality of color images respectively collected by a plurality of color cameras;
projecting an original three-dimensional point cloud corresponding to the target depth image onto the target color image based on a matrix transformation relationship between the depth camera and the color camera, and determining an input viewpoint image based on matched projection points;
determining a user's gaze, determining, based on the user's gaze, a corresponding second gaze region in the input viewpoint image, and performing image fusion processing based on a gaze region image corresponding to the second gaze region, so as to acquire a high-definition gaze region image;
scaling and fusing the input viewpoint image to acquire a low-definition image; and
performing image fusion processing on the high-definition gaze region image and the low-definition image to acquire a to-be-displayed virtual viewpoint image.

2. The image processing method according to claim 1, wherein the determining a user's gaze, and determining a corresponding second gaze region in the input viewpoint image based on the user's gaze comprises:
determining a first user's gaze region in a current virtual viewpoint image on a display screen, and projecting the first gaze region onto the target color image, so as to determine the second gaze region in the input viewpoint image.

3. The image processing method according to claim 2, wherein the determining a first user's gaze region in a current virtual viewpoint image on a display screen comprises:
performing key point detection on a facial image collected by a first camera to determine key point coordinates of key points in a facial image coordinate system;
performing circular fitting processing based on key point coordinates of eye key points, so as to determine pupil coordinates of an eye pupil in a first camera coordinate system;
performing plane fitting processing based on key point pixel coordinates of the eye key points, and determining eye center coordinates of an eye center point in a face coordinate system based on a fitted plane; and determining eye center coordinates of the eye center point in the first camera coordinate system based on a coordinate transformation relationship between the first camera and the face coordinate system;
determining, based on a coordinate transformation relationship between the first camera coordinate system and a screen coordinate system, a gaze direction in the screen coordinate system using the pupil coordinates and the eye center coordinates; and
delineating a gaze region based on the gaze direction.

4. The image processing method according to claim 3, wherein the performing key point detection on a facial image collected by a first camera and determining key point coordinates of key points in a facial image coordinate system comprises:
performing face detection on the facial image to determine pixel coordinates of preset key points in an image coordinate system;
determining key point coordinates of the key points in the first camera coordinate system based on a coordinate transformation relationship between the image coordinate system and the first camera coordinate system; and
acquiring a transformation matrix between the face coordinate system and the first camera coordinate system, so as to acquire key point coordinates of the key points in the face coordinate system using the transformation matrix.

5. The image processing method according to claim 3, wherein the performing circular fitting processing based on key point coordinates of eye key points, so as to determine pupil coordinates of an eye pupil in a first camera coordinate system comprises:
acquiring an eye region image based on an eye key point set;
performing circular fitting processing on the eye region image, so as to acquire pixel coordinates of the eye pupil in an image coordinate system;
calculating an average depth value based on coordinate information of key points in the eye key point set in the first camera coordinate system, and determining the average depth value as a depth value of the eye pupil; and
determining the pupil coordinates of the eye pupil in the first camera coordinate system by combining the pixel coordinates of the eye pupil in the image coordinate system and the depth value of the eye pupil.

6. The image processing method according to claim 3, wherein the determining eye center coordinates of an eye center point in a face coordinate system based on a fitted plane comprises:
determining a geometric center of the fitted plane;
constructing a perpendicular line of the fitted plane passing through the geometric center in a first direction; and
determining a point at a preset length of the perpendicular line as the eye center point, so as to acquire the eye center coordinates of the eye center point in the face coordinate system.

7. The image processing method according to claim 1, wherein the projecting an original three-dimensional point cloud corresponding to the target depth image onto the target color image based on a matrix transformation relationship between the depth camera and the color camera, so as to determine an input viewpoint image based on matched projection points comprises:
projecting the original three-dimensional point cloud corresponding to the target depth image onto each target color image based on a transformation relationship between the depth camera and the color camera, so as to acquire depth information of matched projection points in each target color image; and
projecting the matched projection points in the target color image onto a preset virtual viewpoint image, so as to acquire a plurality of input viewpoint images.

8. The image processing method according to claim 1, further comprising:
performing image recognition on the target color image, and removing a background region based on the image recognition result, so as to calculate the input viewpoint image based on the target color image with the background region removed.

9. (canceled)

10. A non-transitory computer-readable storage medium having a computer program stored thereon, wherein the computer program, when executed by a processor, is configured to:
acquire a target depth image collected by a depth camera and target color images collected by color cameras, wherein the target color images comprise a plurality of color images respectively collected by a plurality of color cameras;
project an original three-dimensional point cloud corresponding to the target depth image onto the target color image based on a matrix transformation relationship between the depth camera and the color camera, and determine an input viewpoint image based on matched projection points;
determine a user's gaze, determine, based on the user's gaze, a corresponding second gaze region in the input viewpoint image, and perform image fusion processing based on a gaze region image corresponding to the second gaze region, so as to acquire a high-definition gaze region image;
scale and fuse the input viewpoint image to acquire a low-definition image; and
perform image fusion processing on the high-definition gaze region image and the low-definition image to acquire a to-be-displayed virtual viewpoint image.

11. An electronic device, comprising:
a processor; and
a memory configured to store executable instructions of the processor, wherein
the processor, when executing the executable instructions, is configured to:
acquire a target depth image collected by a depth camera and target color images collected by color cameras, wherein the target color images comprise a plurality of color images respectively collected by a plurality of color cameras;
project an original three-dimensional point cloud corresponding to the target depth image onto the target color image based on a matrix transformation relationship between the depth camera and the color camera, and determine an input viewpoint image based on matched projection points;
determine a user's gaze, determine, based on the user's gaze, a corresponding second gaze region in the input viewpoint image, and perform image fusion processing based on a gaze region image corresponding to the second gaze region, so as to acquire a high-definition gaze region image;
scale and fuse the input viewpoint image to acquire a low-definition image; and
perform image fusion processing on the high-definition gaze region image and the low-definition image to acquire a to-be-displayed virtual viewpoint image instructions.

12. The electronic device according to claim 11, wherein the processor is further configured to:
determine a first user's gaze region in a current virtual viewpoint image on a display screen, and project the first gaze region onto the target color image, so as to determine the second gaze region in the input viewpoint image.

13. The electronic device according to claim 12, wherein the processor is further configured to:
perform key point detection on a facial image collected by a first camera to determine key point coordinates of key points in a facial image coordinate system;
perform circular fitting processing based on key point coordinates of eye key points, so as to determine pupil coordinates of an eye pupil in a first camera coordinate system;
perform plane fitting processing based on key point pixel coordinates of the eye key points, and determine eye center coordinates of an eye center point in a face coordinate system based on a fitted plane; and determine eye center coordinates of the eye center point in the first camera coordinate system based on a coordinate transformation relationship between the first camera and the face coordinate system;
determine, based on a coordinate transformation relationship between the first camera coordinate system and a screen coordinate system, a gaze direction in the screen coordinate system using the pupil coordinates and the eye center coordinates; and
delineate a gaze region based on the gaze direction.

14. The electronic device according to claim 13, wherein the processor is further configured to:
perform face detection on the facial image to determine pixel coordinates of preset key points in an image coordinate system;
determine key point coordinates of the key points in the first camera coordinate system based on a coordinate transformation relationship between the image coordinate system and the first camera coordinate system; and
acquire a transformation matrix between the face coordinate system and the first camera coordinate system, so as to acquire key point coordinates of the key points in the face coordinate system using the transformation matrix.

15. The electronic device according to claim 13, wherein the processor is further configured to:
acquire an eye region image based on an eye key point set;
perform circular fitting processing on the eye region image, so as to acquire pixel coordinates of the eye pupil in an image coordinate system;
calculate an average depth value based on coordinate information of key points in the eye key point set in the first camera coordinate system, and determine the average depth value as a depth value of the eye pupil; and
determine the pupil coordinates of the eye pupil in the first camera coordinate system by combining the pixel coordinates of the eye pupil in the image coordinate system and the depth value of the eye pupil.

16. The electronic device according to claim 13, wherein the processor is further configured to:
determine a geometric center of the fitted plane;
construct a perpendicular line of the fitted plane passing through the geometric center in a first direction; and
determine a point at a preset length of the perpendicular line as the eye center point, so as to acquire the eye center coordinates of the eye center point in the face coordinate system.

17. The electronic device according to claim 11, wherein the processor is further configured to:
project the original three-dimensional point cloud corresponding to the target depth image onto each target color image based on a transformation relationship between the depth camera and the color camera, so as to acquire depth information of matched projection points in each target color image; and
project the matched projection points in the target color image onto a preset virtual viewpoint image, so as to acquire a plurality of input viewpoint images.

18. The electronic device according to claim 11, wherein the processor is further configured to:
perform image recognition on the target color image, and remove a background region based on the image recognition result, so as to calculate the input viewpoint image based on the target color image with the background region removed.

19. The non-transitory computer-readable storage medium according to claim 10, wherein the computer program, when executed by a processor, is further configured to:
determine a first user's gaze region in a current virtual viewpoint image on a display screen, and project the first gaze region onto the target color image, so as to determine the second gaze region in the input viewpoint image.

20. The non-transitory computer-readable storage medium according to claim 19, wherein the computer program, when executed by a processor, is further configured to:
perform key point detection on a facial image collected by a first camera to determine key point coordinates of key points in a facial image coordinate system;
perform circular fitting processing based on key point coordinates of eye key points, so as to determine pupil coordinates of an eye pupil in a first camera coordinate system;
perform plane fitting processing based on key point pixel coordinates of the eye key points, and determine eye center coordinates of an eye center point in a face coordinate system based on a fitted plane; and determine eye center coordinates of the eye center point in the first camera coordinate system based on a coordinate transformation relationship between the first camera and the face coordinate system;
determine, based on a coordinate transformation relationship between the first camera coordinate system and a screen coordinate system, a gaze direction in the screen coordinate system using the pupil coordinates and the eye center coordinates; and
delineate a gaze region based on the gaze direction.

21. The non-transitory computer-readable storage medium according to claim 20, wherein the computer program, when executed by a processor, is further configured to:
perform face detection on the facial image to determine pixel coordinates of preset key points in an image coordinate system;
determine key point coordinates of the key points in the first camera coordinate system based on a coordinate transformation relationship between the image coordinate system and the first camera coordinate system; and
acquire a transformation matrix between the face coordinate system and the first camera coordinate system, so as to acquire key point coordinates of the key points in the face coordinate system using the transformation matrix.
